(19) United States
(12) Patent Application Publication
(10) Pub. No.: US 2008/0070202 A1
(43) Pub. Date: Mar. 20, 2008

(54) Reading Comprehension System and Associated Methods

(76) Inventors: Jason B. Fisher, Winter Springs, FL (US); Susan E. Elliott, Winter Springs, FL (US)

Correspondence Address: JACQUELINE E. HARTT, PH.D;ALLEN, DYER, DOPPELT, MILBRATH & GILCHRIST, P.A., P.O. BOX 3791, ORLANDO, FL, 32802-3791, US

(21) Appl. No.: 11/469,078

(22) Filed: Aug. 31, 2006

(51) Int. Cl. G09B 19/00

(52) U.S. Cl. 434/156

(57) ABSTRACT

A computer based reading comprehension teaching system that is accessible by a student using a computer having a memory includes a story database, an illustration database, a vocabulary database, and a questions database, each of which are to be stored on the memory. The story database may include a predetermined story. The illustration database may include a respective predetermined illustration relating to a portion of the predetermined story. The vocabulary database may include a vocabulary word relating to a portion of the predetermined story, and a respective definition for the vocabulary word. The questions database may include a question relating to a portion of the predetermined story, and a respective answer to the question. Each of the story database, illustration database, vocabulary database, and questions database may be in communication with one another on the memory.

### FIELD OF THE INVENTION

The present invention relates to the field of reading comprehension and, more particularly, to the field of computer related systems for providing reading comprehension instruction to users, and related methods.

### BACKGROUND OF THE INVENTION

Traditional classroom instruction has been continuously used to enhance reading comprehension of students. Such classroom instruction may include the use of books that are divided into chapters, known as chapter books. After reading a portion of a story in a chapter book, or sometimes, after the entire story is read, a student may be tested on their reading comprehension using a series of questions. Reading comprehension testing is well known and may be found on many standardized tests, including college entrance examinations.

Traditional classroom instruction may also include vocabulary lessons. Such lessons assist students with reading comprehension skills. More specifically, students that are in a rush when reading may skip over words that are not familiar to them. In such a case, the student may not comprehend that which he or she is reading. Accordingly, some teachers have found the need to provide their students with vocabulary lessons to enhance reading comprehension skills.

It has been recognized that there is a need to enhance such traditional methods. Accordingly, there have been attempts to introduce computer-based reading systems.

For example, U.S. Pat. No. 6,632,094 to Falcon, et al discloses an audio/visual technique that presents audio narration together with a video display of printed text. More specifically, the system displays the text from a text box, along with an image related to the story, i.e., a still picture. Further, the system narrates the story to the user while the text of the story is displayed in the text box. The word that is being narrated is simultaneously highlighted in the text box. The system is similar to an illustrated children's book, and has multiple pages that can be flipped through using a “back” button and a “next” button.

Unfortunately, such a system does not enhance reading comprehension skills of the user as it does not truly require the user to read. Instead, the user merely follows along with a story as the story is being narrated.

U.S. Published Patent Application No. 2002/0156632 by Haynes, et al discloses a computer-based reading tutoring system. The system includes a plurality of instructional passages of different predetermined levels of difficulty. The system automatically evaluates a student's submitted summary of a selected instructional passage, and thereafter automatically determines which instructional passage the student should read next. The system also provides immediate feedback data and includes an indicator reflective of the student's reading comprehension. This system, however, is more suitable to test the level of a student's reading comprehension skills. After the student's reading comprehension level is determined, a suitable story is selected for the student.

U.S. Pat. No. 6,361,322 to Linden Henry discloses a computer system to improve reading comprehension. The computer system includes a reading passage stored on a memory. The system also includes a first question stored on the memory that tests the user's ability to identify information from the passage, and a second question stored on the memory that tests the user's ability to infer a conclusion from the passage. The system also includes a test module that presents a reading passage to the user as well as the first and second questions to the user. This type of system, however, may not be suitable for less advanced children and, further, fails to provide other aids to a student to assist the student in comprehending the story.

U.S. Pat. No. 6,644,973 to Oster discloses a system for improving a user's reading speed and comprehension. More particularly, the user reads aloud into a microphone attached to an amplifier in a headset. The amplifier sends the user's voice to an ear phone receiver positioned on the headset and, more specifically, adjacent the user's dominant ear. This allows the user to hear and assimilate his/her own reading. The system also discloses that the user should be positioned in front of a mirror to observe posture and lip movement, and make adjustments to those reading protocol components.

This system, however, may be somewhat complicated for purposes of enhancing the reading comprehension ability of a student. This system also fails to provide aids to a student to assist the student in comprehending the story. Accordingly, the need arises for a simplified computer-based reading comprehension system that may be readily used by any student.

### SUMMARY OF THE INVENTION

In view of the foregoing background, it is therefore an object of the present invention to provide a reading comprehension teaching system to readily enhance reading comprehension skills of a student. It is also an object of the present invention to provide a reading comprehension system that is readily loadable onto a memory of a computer. It is further an object of the present invention to provide a reading comprehension system that is readily updatable by a user.

These and other objects, features, and advantages in accordance with the present invention are provided by a computer-based reading comprehension teaching system that may be accessible by a student using the computer. The computer may have a memory, and the system may include a story database, an illustration database, a vocabulary database, and a questions database. Each of the databases are in communication with one another when stored on the memory.

The story database may comprise a plurality of predetermined stories. The illustration database may comprise a plurality of predetermined illustrations relating to a portion of the predetermined stories. The vocabulary database may comprise a plurality of vocabulary words relating to portions of the predetermined stories, and respective definitions for each of the vocabulary words. The questions database may comprise a plurality of questions relating to portions of the predetermined stories, and respective answers to the plurality of questions.

In one embodiment of the invention, the story database, the illustration database, the vocabulary database, and the questions database are stored on software. The software may be selectively interfaced with the computer to load the story database, the illustration database, the vocabulary database, and the questions database onto the memory.

In another embodiment of the invention, the story database, the illustration database, the vocabulary database, and the questions database are stored on a global communications network that is accessible by a user. The global communications network may be selectively interfaced with the computer to load the story database, illustration database, vocabulary database, and questions database onto the memory.

Both embodiments of the invention advantageously allow a user various options when using the reading comprehension teaching system. For example, the software embodiment of the invention allows a user to readily load the above-referenced databases onto the memory of the computer without the need to access a global communications network. Similarly, the global communications network embodiment of the invention allows a user to load the above-referenced databases onto the memory of the computer without the need to use software.

The questions database may include a detailed questions database and a reading comprehension questions database. The detailed questions database may include a question relating to details of the predetermined stories. The detailed questions database may also include answers to the questions relating to the details of the stories.

The reading comprehension questions database may include questions relating to comprehension of the stories, and respective answers to those questions. Accordingly, the questions database advantageously enhances a student's ability to remember details of a story, as well as enhances the student's reading comprehension skills.

The vocabulary database may include illustrations relating to the vocabulary words and definitions. More specifically, the illustrations advantageously enhance a user's understanding of a vocabulary word that may be located throughout a story.

The system may also comprise an automation module that automatically performs various tasks. The automation module may display the story from the story database to the user, display the respective illustration from the illustration database to the user at a predetermined point in the story, and may display the vocabulary word and respective definition to the user from the vocabulary database.

Further, the automation module may prompt a user with questions from the questions database at predetermined points in the stories. The automation module may also provide the user with an indication of whether the answers to the questions are correct. Accordingly, the automation module advantageously identifies predetermined points of the stories where questions may be applicable applicable.

The story database, the illustration database, the vocabulary database, and the questions database are advantageously updatable. Updating may be achieved by accessing a global communications network and downloading updates to a computer. Updates may also be achieved by loading update software onto the computer.

### BRIEF DESCRIPTION OF THE DRAWINGS

FIG. 1 is a partial environmental view of a student using the reading comprehension teaching system according to the present invention.

FIG. 2 is a schematic diagram of a reading comprehension teaching system according to the present invention.

FIG. 3 is a schematic diagram of an embodiment of the reading comprehension teaching system that is software based.

FIG. 4 is a schematic diagram of another embodiment of the reading comprehension teaching system that is accessible using a global communications network.

FIG. 5 is a flow chart illustrating a method of using the embodiment of the reading comprehension teaching system illustrated in FIG. 3.

FIG. 6 is a flow chart illustrating a method of using the embodiment of the reading comprehension teaching system illustrated in FIG. 4.

FIG. 7 is a flow chart illustrating a method of updating the embodiment of the reading comprehension teaching system illustrated in FIG. 3.

FIG. 8 is a flow chart illustrating a method of updating the embodiment of the reading comprehension teaching system illustrated in FIG. 4.

### DETAILED DESCRIPTION OF THE PREFERRED EMBODIMENTS

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout, and prime notation is used to indicate similar elements in alternate embodiments.

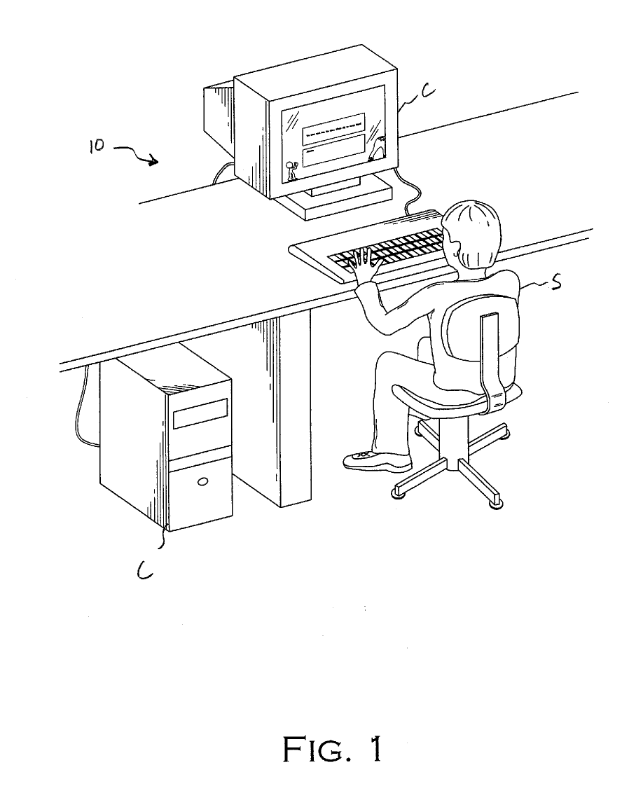

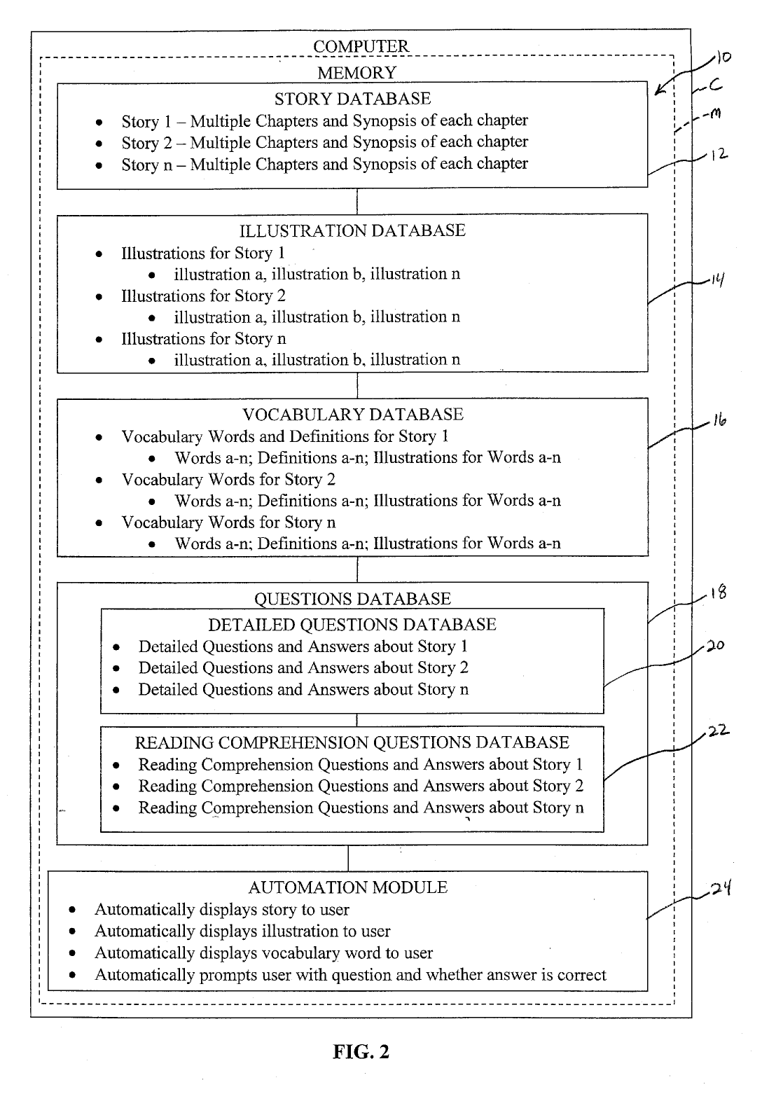

Referring initially to FIGS. 1-2, a computer based reading comprehension teaching system 10 according to the present invention is now described. The computer based reading comprehension teaching system 10 is preferably accessible by a student S using a computer C having a memory M. Although a student S is displayed in the figures as using the system 10, those skilled in the art will appreciate that the system is not only to be used by students, but by any user desiring to enhance their reading comprehension ability. Accordingly, student and user are used interchangeably throughout this specification.

The student S may access the system 10 using a personal computer C, for example, or a computer connected to a network, such as in a classroom, for example. Those skilled in the art will appreciate that the memory M may be stored on the computer C, such as a desktop computer or a laptop computer, for example, or may be a memory on a server that the computer is connected to, or any other type of memory that the computer may be in communication with.

The system 10 may include a plurality of databases to be stored on the memory M of the computer C. The plurality of databases are preferably in communication with one another so that a student S may advantageously enhance his or her reading comprehension skills. More particularly, the databases provide the student S the opportunity to read stories that are generally found in chapter books, i.e., books having stories divided into a plurality of chapters. Chapter books are used by teachers in reading comprehension lesson plans, along with various other aids to ensure that the student's reading comprehension skills are enhanced.

The system 10 illustratively includes a story database 12 that is to be stored on the memory M of the computer C. As illustrated in FIG. 2, for example, the story database 12 may include stories 1, 2, and n, wherein “n” is representative of any number story. Accordingly, those skilled in the art will appreciate that the story database 12 may include any number of stories. The story database 12 preferably comprises a plurality of stories, such as the stories described above that may be found in chapter books. Those skilled in the art will appreciate, however, that the story database 12 may include any type of story and, more specifically, any type of reading text.

More specifically, each story preferably includes a plurality of chapters. Further, a synopsis of each chapter may be provided to the student S prior to accessing each chapter. The synopsis advantageously provides the student S with background knowledge, as necessary. For example, the synopsis may provide background information of a particular character that may be introduced in the chapter.

The system 10 also preferably includes an illustration database 14 that is to be stored on the memory M of the computer C. The illustration database 14 may include respective predetermined illustrations that relate to portions of the stories in the story database 12. For example, the illustration database 14 may include sub-databases, each including a plurality of illustrations relating to each story. Accordingly, a first sub-database in the illustration database 14 may include illustrations relating to story 1 in the story database 12.

The illustrations database 14 may also advantageously interface with the synopsis of each story in the story database 12. In other words, if the synopsis provides background information about a character being introduced in a particular chapter, the illustration database may provide an illustration of that character.

A plurality of illustrations relating to various portions of story 1 may be included in the first sub-database. Those skilled in the art will appreciate that the illustration database 14 preferably includes as many sub-databases as there are stories in the story database 12.

The system 10 also illustratively includes a vocabulary database 16 to be stored on the memory M of the computer C. The vocabulary database 16 may include a plurality of vocabulary words that relate to portions of the stories on the story database 12, and respective definitions for the vocabulary words. The vocabulary database 16 may also include a plurality of illustrations relating to the vocabulary words. The illustrations advantageously enhance the student's understanding of the vocabulary word by providing a visualization of the word.

Similar to the illustration database 14, the vocabulary data 16 may include sub-databases relating to each story. Accordingly, a first sub-database in the vocabulary database 16 may include vocabulary words, and respective definitions, that are found in story 1 in the story database 12.

A plurality of vocabulary words and definitions relating to various portions of story 1 may be included in the first sub-database. Those skilled in the art will appreciate that the vocabulary database 16 preferably includes as many sub-databases as there are stories in the story database 12.

The system 10 also preferably includes a questions database 18 to be stored on the memory M of the computer C. The questions database 18 includes a plurality of questions relation to portions of the stories on the story database 12, and respective answers to the questions. Similar to both the illustration database 14 and the vocabulary data 16, the questions database 18 may include sub-databases relating to each story. Accordingly, a first sub-database in the questions database 18 may include questions, and respective answers, relating to story 1 in the story database 12.

A plurality of questions and answers relating to various portions of story 1 may be included in the first sub-database. Those skilled in the art will appreciate that the questions database 18 preferably includes as many sub-databases as there are stories in the story database 12. As will be discussed in greater detail below, the questions database 18 may include a detailed questions database 20 and a reading comprehension database 22.

The detailed questions database 20 and the comprehension questions database 22 are advantageously used to monitor progress of a student's reading comprehension, as well as provide indications of the student's progression through the teaching system, i.e., provide an indication of whether the student's reading comprehension skills have progressed enough to move to a more difficult story.

Each of the story database 12, the illustration database 14, the vocabulary database 16 and the questions database 18 are in communication with one another when stored on the memory M of the computer C. More particularly, after being stored on the memory M of the computer C, the databases 12, 14, 16, 18 are in communication with one another. This advantageously allows the databases 12, 14, 16, 18 to be separately uploaded to the memory M of the computer C or, if desired, be uploaded together. Further, and as will be discussed in greater detail below, the databases 12, 14, 16, 18 may be separately updated, as necessary.

As briefly discussed above, the questions database 18 includes a detailed questions database 20 and a reading comprehension questions database 22. The detailed questions database 20 preferably includes questions relating to details of portions of the stories on the story database 12, and respective answers to the questions. The detailed questions database 20 may include a plurality of sub-databases relating to each story. In other words, the detailed questions database 20 may include a first sub-database that includes questions, and respective answers, relating to details of story 1 in the story database 12.

A plurality of detailed questions and answers relating to details of story 1 may be included in the first sub-database. Those skilled in the art will appreciate that the detailed questions database 20 preferably includes as many sub-databases as there are stories in the story database 12.

Similarly, the reading comprehension database 22 includes questions relating to comprehension of the stories on the story database 12, and respective answers to the comprehension questions. The reading comprehension questions database 22 may include a plurality of sub-databases relating to each story. In other words, the reading comprehension questions database 22 may include a first sub-database that includes comprehension questions, and respective answers, relating to comprehension of story 1 in the story database 12.

A plurality of comprehension questions, and answers relating to comprehension of story 1, may be included in the first sub-database. Those skilled in the art will appreciate that the reading comprehension questions database 22 preferably includes as many sub-databases as there are stories in the story database 12.

The system 10 also includes an automation module 24 that is in communication with each of the databases 12, 14, 16, 18 when stored on the memory M of the computer C. More particularly, the automation module 24 may automatically performs a variety of functions when the system 10 is running on the computer C. For example, the automation module 24 may automatically display a story from the story database 12. More particularly, the automation module may display a story from the story database 12 when prompted by the user, or may display the story upon starting the program.

Those skilled in the art will appreciate that the automation module 24 of the system may allow a student S to access the stories on the story database 12 in a predetermined order. For example, the automation module 24 may automatically display the next story in a sequence of stories having increasing difficulty upon completion of a less difficult story. The automation module 24 may, of course, allow for advancement of the student S to the next story upon a showing, through the questions and answers on the detailed questions database 20 and the reading comprehension questions database 22, that the student has achieved a predetermined level of reading comprehension skill.

The automation module 24 may also automatically display illustrations from the illustration database 14 at a predetermined point in each story on the story database 12. For example, as the student S is reading a story on the story database 12, the automation module 24 may display an illustration from the illustration database 14 relating to a certain point in the story that the student has reached. The illustrations from the illustration database 14 advantageously assist the student S in comprehending the story as they provide visualizations to the student to better understand the story.

The automation module 24 may further automatically display vocabulary words and related definitions from the vocabulary database 16 to the student. More particularly, the automation module 24 may display the vocabulary words and definitions from the vocabulary database 16 when the student reaches the particular vocabulary word in the story. This advantageously enhances the student's comprehension of the story as it provides the student the definitions to the vocabulary words found in the story.

A major problem for students that struggle with reading comprehension is an understanding of vocabulary the words in the stories. The automation module 24 of the reading comprehension teaching system 10, together with the vocabulary database 16, solves this problem by providing students with the definitions to the vocabulary words found in the stories.

Alternately, the automation module 24 may display the vocabulary word and definition from the vocabulary database 16 when prompted by the student S. In other words, the vocabulary word and definition will not be displayed until the student S prompts the system 10 to so display the information. This advantageously allows a student S to use the system 10 at his or her own pace.

Some students S may be more advanced than others and, accordingly, may know more vocabulary words than others. Accordingly, such students S may not need to view the definitions of as many vocabulary words found in the stories. Those students S may, therefore, only view the definitions of the vocabulary words that are necessary to further enhance their reading comprehension skills.

The automation module 24 may also display illustrations relating to the vocabulary words and definitions in the vocabulary database 16. The illustrations may, for example, be automatically displayed to the student S when the definition to the vocabulary word is displayed. Alternately, the illustration relating to the vocabulary word may be displayed when prompted by the student S. The illustration advantageously enhances student's reading comprehension skills by providing a visualization relating to the definition of the vocabulary word. Further, selective display of the illustrations by the student S allows the student to learn at his or her own pace.

The automation module 24 may further advantageously automatically prompt a student S with questions from the questions database 18 at a predetermined point in the story. More specifically, and as discussed in detail above, the student S may be automatically prompted with questions from the detailed questions database 20 and the reading comprehension questions database 22.

The student S may be prompted with the questions at predetermined points in the story. As discussed above, the stories are preferably subdivided into chapters, i.e., chapter books that are generally used by teachers to teach reading comprehension lessons. Accordingly, the student S may be prompted with questions from the detailed questions database 20 and the reading comprehension question database 22 at the end of each chapter, or at the end of the story. Those skilled in the art will appreciate that a student S will find questions more difficult if they have read more of the story before answering the questions.

The automation module 24 also provides an indication of whether or not the student S has correctly answered the questions from the detailed questions database 20 and the reading comprehension questions database 22. If, for example, the student S answers a question incorrectly, the student may be prompted with the question again, may be directed to re-read a portion of the story, may be directed to re-read the entire story, or may even be directed to the portion of the story where the correct answer may be found.

The automation module 24 advantageously monitors progress of the student S to determine the level of the student's reading comprehension. Accordingly, the automation module 24 advantageously prevents a student S from advancing beyond their capability. Further, the automation module 24 also advantageously allows the student S to learn at their own pace, and moves a student forward when the student is ready, according to results gauged by questions from the questions database 18.

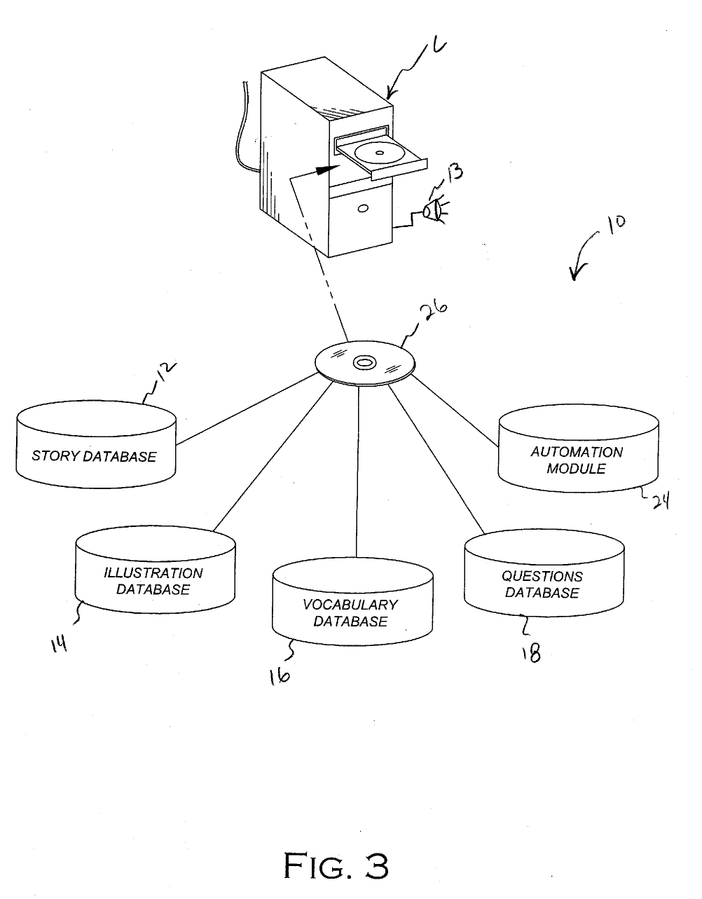

Referring now additionally to FIG. 3, a software-based embodiment of the reading comprehension teaching system 10 is now described in greater detail. The story database 12, the illustration database 14, the vocabulary database 16, and the questions database 18, are preferably stored on software 26. The software 26 may, for example, be a disk that may be selectively interfaced with the computer C. Upon interfacing the disk 26 with the computer, the databases 12, 14, 16, 18 may be loaded onto the memory M of the computer C. The software-based embodiment of the reading comprehension teaching system 10 advantageously allows for the databases 12, 14, 16, 18, as well as the automation module 24, to be individually loaded onto the memory M of the computer C.

As will be discussed in greater detail below, the reading comprehension teaching system 10 is preferably updatable. More specifically, the story database 12, the illustration database 14, the vocabulary database 16, and the questions database 18 are all updatable. Further, the automation module 24 may also be updatable, if updates become available. When using a software-based version of the system 10, each of the databases 12, 14, 16, 18, may be individually updated as necessary. In other words, an update to the story database 12 may be provided to the user in the form of a disk, or other software. Accordingly, the story database 12 may be updated separately from the illustration database 14, the vocabulary database 16, and the questions database 18.

As illustrated in FIG. 3, the computer C may advantageously include a speaker 13. The speaker 13 advantageously provides the user with an option to have anything stored on any of the databases read aloud. For example, a synopsis of a chapter of story 1 on the story database 12 may be selectively read aloud to the user, if so desired. Similarly, the vocabulary words and definitions may be read from the vocabulary database 16, and the questions stored on the questions database 18 may also be read aloud. Those skilled in the art will appreciate that any text data stored on the databases may be read aloud to the user.

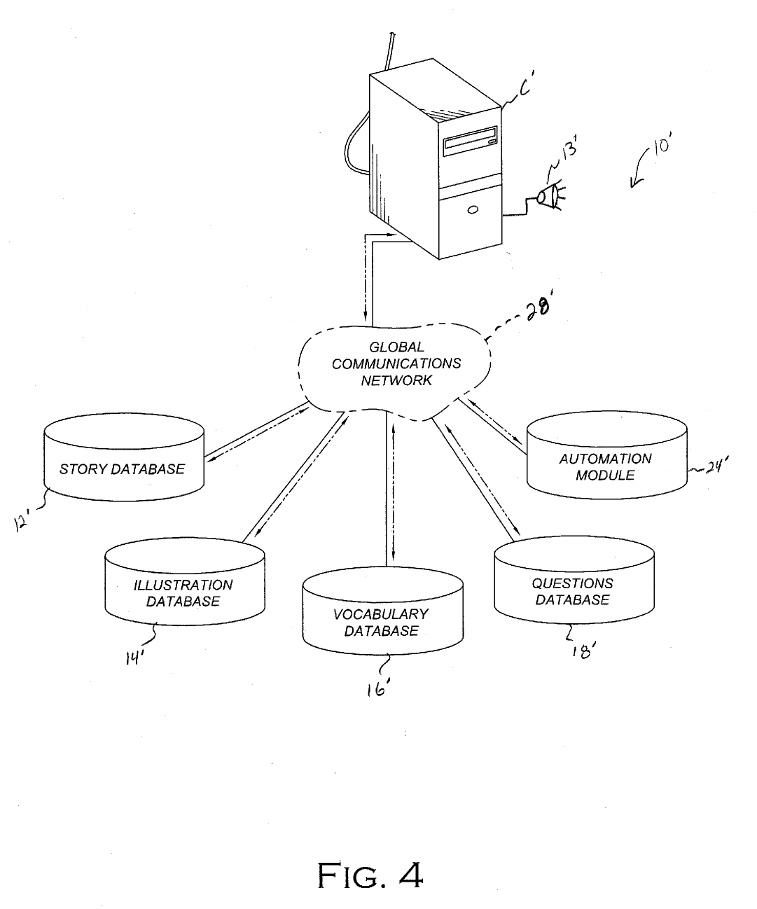

Referring now additionally to FIG. 4, another embodiment of the reading comprehension teaching system 10′ is now described in greater detail. In this embodiment of the reading comprehension teaching system 10′, the software database 12′, the illustration database 14′, the vocabulary database 16′, and the questions database 18′ are stored on a global communications network 28′, i.e., the Internet. The automation module 24′ is also preferably stored on the global communications network 28′.

The global communications network 28′ is selectively interfaced with the computer C′. In other words, the computer C′ may have access to the global communications network 28′, i.e., may have access to the Internet. When the computer's C′ is interfaced with the global communications network 28′, the databases 12′, 14′, 16′, 18′, and the automation module 24′ may be accessed by a user so that the databases may be loaded and stored onto the memory M′ of the computer C′.

The web-based, or network-based, embodiment of the system 10′ advantageously eliminates the need to produce software, and deliver that software to the user. Further, access to global communications networks 28′ is very common in this day and age, and most users would be able to readily access a global communications network to download the databases 12′, 14′, 16′, 18′, as well as the automation module 24′. The other aspects of this embodiment of the invention are similar to those of the first embodiment of the invention, are labeled with prime notation, and require no further discussion herein. Further, some aspects of the second embodiment of the invention described above have been given a prime notation, but are similar to those illustrated in the first embodiment of the invention, and may not be shown in the appended drawings.

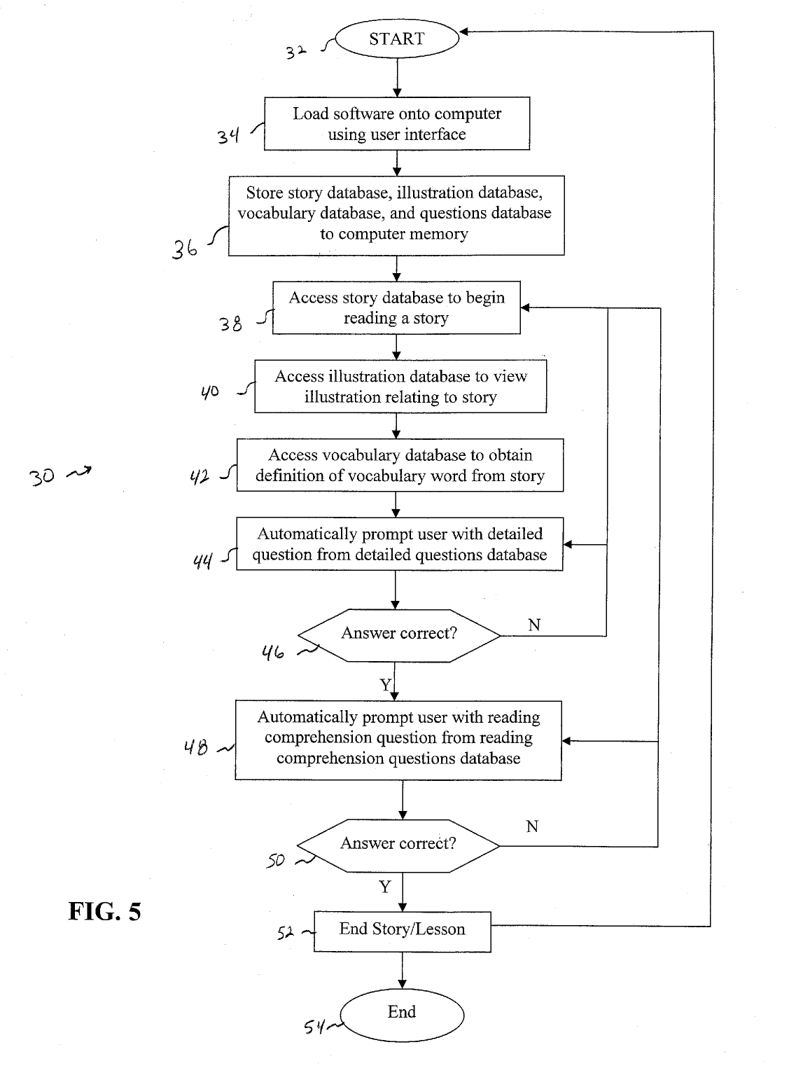

Referring now more particularly to the flowchart 30 of FIG. 5, a method aspect of the present invention is now described in greater detail. From the start (Block 32), software 26 is loaded onto the computer C using a user interface at Block 34. The user interface may, for example, be a keyboard of the computer C, or any other user interface as understood by those skilled in the art.

At Block 36, the story database 12, the illustration database 14, the vocabulary database 16, and the questions database 18 are stored to the memory M of the computer C. At Block 38, the story database 12 is accessed by a user to begin reading a story. At Block 40, the illustration database 14 is accessed to view an illustration relating to the story. At Block 42, the vocabulary database 16 is accessed to obtain a definition of a vocabulary word found in the story.

At Block 44, the user is automatically prompted with a detailed question from the detailed questions database 20. At Block 46, it is determined whether the answer to the question from the detailed questions database 20 is correct. If the answer is not correct, the user may either be automatically prompted with the same question from the detailed questions database 20 at Block 44, or may be directed to re-read the story at Block 38. As described above, however, several other options may also be available. For example, if the student answers the question incorrectly, the student may be prompted with the question again, may be directed to re-read a portion of the story, may be directed to re-read the entire story, or may even be directed to the portion of the story where the correct answer may be found.

If, however, at Block 46, it is determined that the student has answered the question form the detailed questions database 20 correctly, then the student S may be automatically prompted with a reading comprehension question from the reading comprehension questions database 22 at Block 48. If it is determined at Block 50 that the student S has answered the question correctly, then the lesson may be ended at Block 52.

If, however, it is determined at Block 50 that the student has answered the question from the reading comprehension questions database incorrectly, then the student may be directed to answer the question again at Block 48, or may be directed to re-read the story at Block 38. From Block 52, the method may end at Block 54 or, if so desired by the student S, the student may start the method again at Block 32.

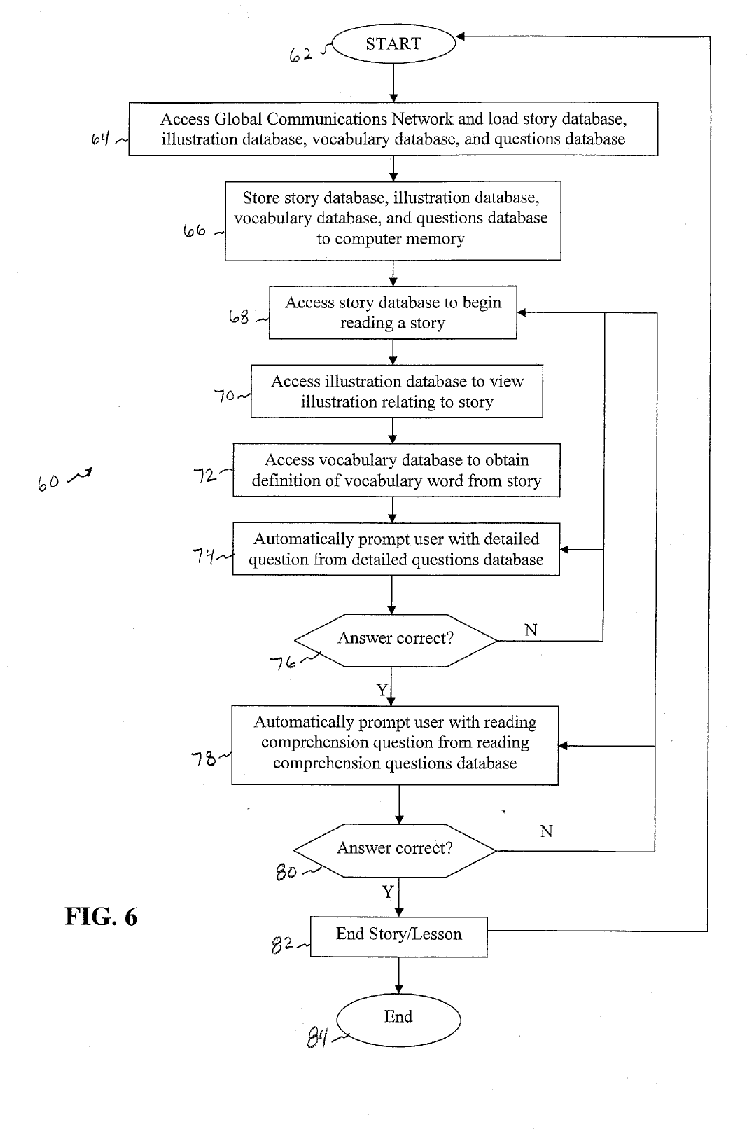

Referring now more specifically to the flowchart 60 of FIG. 6, a method of using the second embodiment of the reading comprehension system 10′ is now described in greater detail. From the start (Block 62), a global communications network 28′ is accessed so that a user may load the story database 12′, the illustration database 14′, the vocabulary database 16′, and the questions database 18′ at Block 64. At Block 66, the databases 12′, 14′, 16′, 18′ are stored onto the memory M of the computer C.

At Block 68, the story database 12′ is accessed so that the student S may begin reading a story. At Block 70, the illustration database 14′ is accessed so that the student S may view an illustration relating to the story. At Block 72, the vocabulary database 16′ is accessed so that the user may obtain a definition of a vocabulary word from the story.

At Block 74, the student S may be automatically prompted with a detailed question from the detailed questions database 20′. At Block 76, it is determined whether the answer to the question is correct. If the answer to the question at Block 76 is incorrect, the student S may be prompted with the question again at Block 74. Alternately, the student S may be prompted to begin reading the story again at Block 68. As described above, in the case of an incorrect answer at Block 76, the student S may be prompted with any number of actions, including being directed to a portion of the story where the correct answer may be found, or may be prompted to re-read a particular portion of the story.

If, however, it is determined at Block 76 that the answer to the detailed question is correct, then the student S may be automatically prompted with a reading comprehension question from the reading comprehension questions database 22′. At Block 80, it is determined whether the answer to the question from the reading comprehension questions database 22′ is correct. If the answer is incorrect, then the student S may be prompted to answer the question again at Block 78, or may be prompted to re-read the story at Block 68. If, however, it is determined that the answer is correct at Block 80, then the story is ended at Block 82. From Block 82, the method may be ended at Block 84 or, if so desired by the student S, the method may be re-started at Block 62.

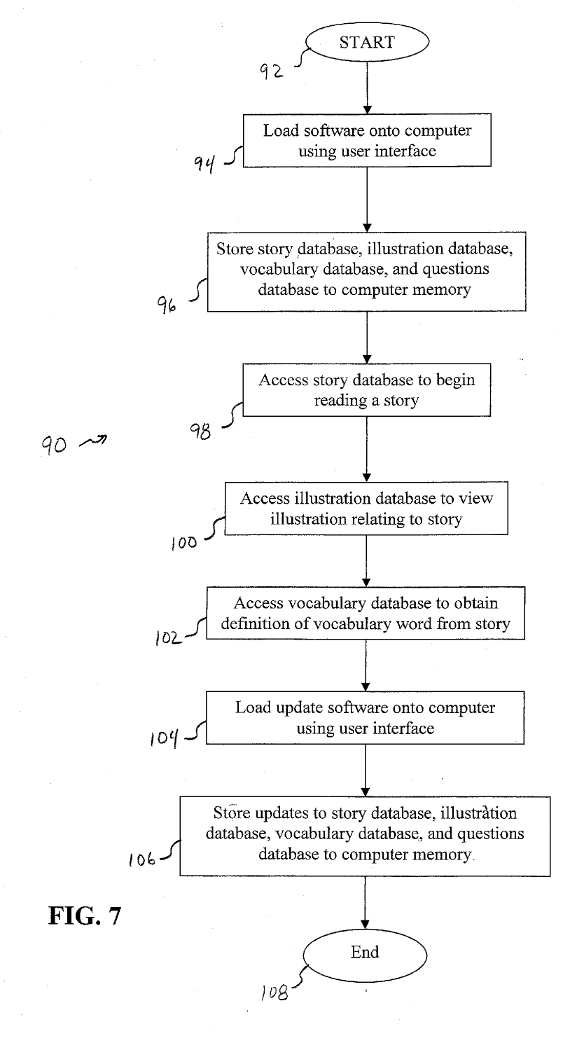

Referring now additionally to the flowchart 90 of FIG. 7, another method aspect of the present invention is now described in greater detail. From the start (Block 92), a software 26 is loaded onto the computer C using the user interface at Block 94. At Block 96, the databases 12, 14, 16, 18 are stored onto the memory M of the computer C.

At Block 98, a story on the story database 12 is accessed so that a student S may begin reading. At Block 100, an illustration on the illustration database 14 is accessed so that the student S may view an illustration relating to the story. At Block 102, the vocabulary database 16 is accessed so that a student S may obtain a definition of a vocabulary word from the story.

At Block 104, update software is loaded onto the computer C using the user interface. At Block 106, updates to the story database 12, the illustration database 14, the vocabulary database 16, and the questions database 18 are stored to the memory M of the computer C. The method is ended at Block 108.

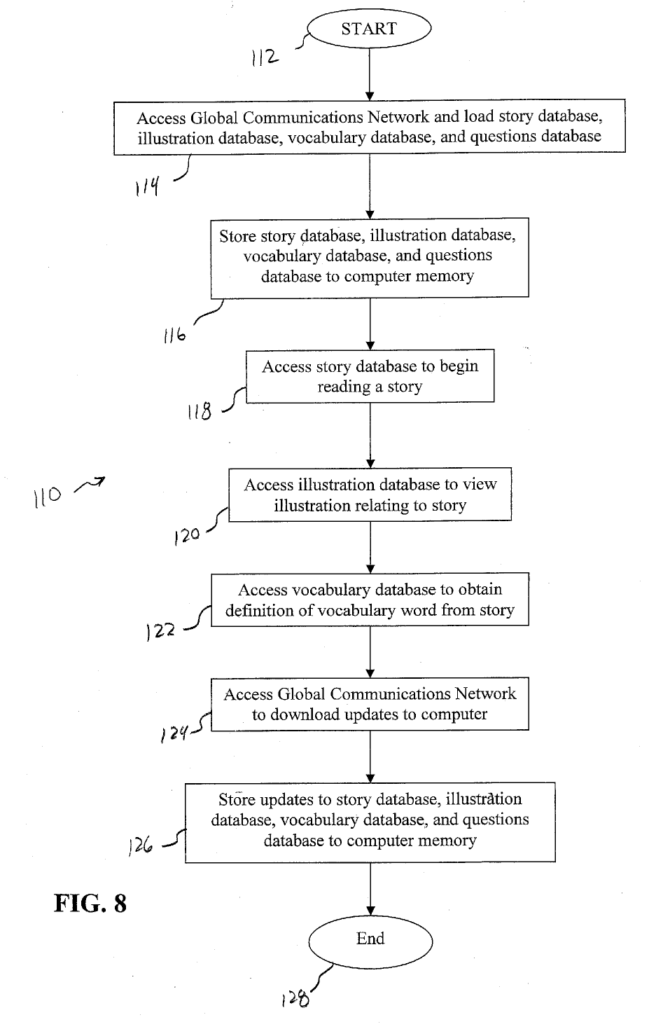

Referring now additionally to the flowchart 110 of FIG. 8, another method aspect for using the second embodiment of the reading comprehension teaching system 10′ is now described in greater detail. From the start (Block 112), a global communications network 28′, i.e., the Internet, is accessed and the databases 12′, 14′, 16′, 18′ are loaded at Block 114. At Block 116, the databases 12′, 14′, 16′, 18′ are stored to the memory M of the computer C. At Block 118, a story is accessed on the story database 12′ so that a student S may begin reading the story. At Block 120, an illustration on the illustration database 14′ is accessed by the student S so that the student may view an illustration relating to the story. The vocabulary database 16′ is accessed at Block 122 to obtain a definition of a vocabulary word from the story.

At Block 124, the global communications network 28′ is accessed to download updates to databases 12′, 14′, 16′, 18′ to the computer C. At Block 126, the updates to the databases 12′, 14′, 16′, 18′ are stored to the memory M of the computer C. The method is ended at Block 128.

Many modifications and other embodiments of the invention will come to the mind of one skilled in the art having the benefit of the teachings presented in the foregoing descriptions and the associated drawings. Therefore, it is understood that the invention is not to be limited to the specific embodiments disclosed, and that modifications and embodiments are intended to be included within the scope of the appended claims.

That which is claimed is:

1. A computer based reading comprehension teaching system accessible by a student using a computer, the computer having a memory, the system comprising:
a story database to be stored on the memory, said story database comprising at least one predetermined story;
an illustration database to be stored on the memory and comprising at least one respective predetermined illustration relating to a portion of the at least predetermined story;
a vocabulary database to be stored on the memory and comprising at least one vocabulary word relating to a portion of the at least one predetermined story, and a respective at least one definition for the at least one vocabulary word; and
a questions database to be stored on the memory and comprising at least one question relating to a portion of the at least one predetermined story, and a respective at least one answer to the at least one question;
wherein each of said story database, illustration database, vocabulary database, and questions database are in communication with one another when stored on the memory.

2. A system according to claim 1 wherein said story database, said illustration database, said vocabulary database, and said questions database are stored on software; and wherein the software is selectively interfaced with the computer to load said story database, said illustration database, said vocabulary database, and said questions database onto the memory.

3. A system according to claim 1 wherein said story database, said illustration database, said vocabulary database, and said questions database are stored on a global communications network accessible by a user, and wherein the global communications network is selectively interfaced with the computer to load said story database, said illustration database, said vocabulary database, and said questions database onto the memory.

4. A system according to claim 1 wherein said questions database comprises at least one of a detailed questions database and a reading comprehension questions database.

5. A system according to claim 4 wherein said detailed questions database comprises at least one question relating to details of the at least one predetermined story and a respective at least one answer to the at least one question.

6. A system according to claim 4 wherein said reading comprehension questions database comprises at least one question relating to comprehension of the at least one predetermined story as it is read, and a respective at least one answer to the at least one question relating to comprehension.

7. A system according to claim 1 wherein said vocabulary database further comprises a respective at least one illustration relating to the respective at least one vocabulary word and definition.

8. A system according to claim 1 further comprising an automation module that automatically performs at least one of displays the at least one story from said story database to the user, displays the respective at least one illustration from said illustration database to the user at a predetermined point in the at least one story, displays the at least one vocabulary word and respective definition to the user from said vocabulary database, and prompts the user with the at least one question from said questions database at a predetermined point in the at least one story.

9. A system according to claim 8 wherein said automation module provides the user with an indication of whether an answer to the at least one question is correct.

10. A system according to claim 1 wherein said story database, said illustration database, said vocabulary database, and said questions database are updatable.

11. A method of using a computer based reading comprehension teaching system, the method comprising:
loading software onto a computer using a user interface, the software comprising
a story database including at least one predetermined story,
an illustration database including at least one respective predetermined illustration relating to a portion of the at least predetermined story,
a vocabulary database including at least one vocabulary word relating to a portion of the at least one predetermined story, and a respective at least one definition for the at least one vocabulary word, and
a questions database including at least one question relating to a portion of the at least one predetermined story, and a respective at least one answer to the at least one question;
storing the story database, the illustration database, the vocabulary database, and the questions database on a memory of the computer so that each of the story database, the illustration database, the vocabulary database, and the questions database are in communication with one another; and
accessing each of the story database, illustration database, vocabulary database, and questions database using a user interface connected to the computer.

12. A method according to claim 11 wherein the questions database comprises at least one of a detailed questions database and a reading comprehension questions database; wherein the detailed questions database comprises at least one question relating to details of the at least one predetermined story and a respective at least one answer to the at least one question; and wherein the reading comprehension questions database comprises at least one question relating to comprehension of the at least one predetermined story, and a respective at least one answer to the at least one question relating to comprehension.

13. A method according to claim 11 wherein the vocabulary database further comprises a respective at least one illustration relating to the respective at least one vocabulary word and definition.

14. A method according to claim 11 further comprising automatically prompting the user with the at least one question from the questions database at a predetermined point in the at least one story.

15. A method according to claim 14 further comprising providing the user with an indication of whether an answer to the at least one question is correct.

16. A method of using a computer based reading comprehension teaching system, the method comprising:
loading a plurality of databases onto a computer, the plurality of databases being stored on a global communications network accessible by a user, the plurality of databases comprising
a story database including at least one predetermined story,
an illustration database including at least one respective predetermined illustration relating to a portion of the at least predetermined story,
a vocabulary database including at least one vocabulary word relating to a portion of the at least one predetermined story, and a respective at least one definition for the at least one vocabulary word, and
a questions database including at least one question relating to a portion of the at least one predetermined story, and a respective at least one answer to the at least one question;
storing the story database, the illustration database, the vocabulary database, and the questions database on a memory of the computer so that each of the story database, the illustration database, the vocabulary database, and the questions database are in communication with one another;
accessing each of the story database, illustration database, vocabulary database, and questions database using a user interface connected to the computer; and
updating each of the story database, the illustration database, the vocabulary database, and the questions database by accessing and downloading updates from the global communications network.

17. A method according to claim 16 wherein the questions database comprises at least one of a detailed questions database and a reading comprehension questions database; wherein the detailed questions database comprises at least one question relating to details of the at least one predetermined story and a respective at least one answer to the at least one question; and wherein the reading comprehension questions database comprises at least one question relating to comprehension of the at least one predetermined story, and a respective at least one answer to the at least one question relating to comprehension.

18. A method according to claim 16 wherein the vocabulary database further comprises a respective at least one illustration relating to the respective at least one vocabulary word and definition.

19. A method according to claim 16 further comprising automatically prompting the user with the at least one question from the questions database at a predetermined point in the at least one story.

20. A method according to claim 19 further comprising providing the user with an indication of whether an answer to the at least one question is correct.
